(19) United States
(12) Patent Application Publication
(10) Pub. No.: US 2025/0357698 A1
(43) Pub. Date: Nov. 20, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nungna WI, Mie (JP); Teruo HARA, Mie (JP)

(21) Appl. No.: 18/873,328

(22) PCT Filed: Jun. 2, 2023
(86) PCT No.: PCT/JP2023/020621

§ 371 Date: Dec. 10, 2024

(30) Foreign Application Priority Data
Jun. 13, 2022 (JP) 2022-094971

(51) Int. Cl. H01R 13/52

(52) U.S. Cl. CPC H01R 13/521

(57) ABSTRACT

A connector of the present disclosure is connectable to a mating connector including a mating receptacle and includes a housing including a tower portion fittable into the mating receptacle and a rubber plug to be externally fit to the tower portion. The rubber plug includes an annular water stop portion to be arranged between an outer peripheral surface of the tower portion and an inner peripheral surface of the mating receptacle with the tower portion fit in the mating receptacle, a tubular vibration resistance portion extending forward along the outer peripheral surface of the tower portion from the water stop portion and a turn-up suppressing portion bridged in a front end part of the vibration resistance portion for suppressing the rubber plug from being turned up rearward by being caught by a front end part of the tower portion.

### TECHNICAL FIELD

The present disclosure relates to a connector.

### BACKGROUND

A connector described in Japanese Patent Laid-Open Publication No. 2020-115445 (Patent Document 1 below) is known as a connector using a rubber ring to improve the vibration resistance of the connector. This connector is provided with a terminal, a housing including a cavity for accommodating the terminal and a tower portion projecting forward, a liquid-tight ring to be externally fit to the tower portion, a vibration resistant ring to be externally fit to the tower portion at a position forward of the liquid-tight ring and a retainer for holding the vibration resistant ring by being mounted into a front end part of the tower portion. According to this connector, the liquid tightness of the connector can be improved by the liquid-tight ring and the vibration resistance of the connector can be improved by the vibration resistant ring.

### PRIOR ART DOCUMENT

### Patent Document

Patent Document 1: JP 2020-115445 A

### SUMMARY OF THE INVENTION

### Problems to be Solved

Since the liquid-tight ring and the vibration resistant ring are respectively necessary and the retainer for holding the vibration resistant ring is necessary in the above connector, the number of components increases. As a countermeasure against this, it is thought to form, for example, an integrated rubber ring by integrating the liquid-tight ring and the vibration resistant ring. By doing so, only one rubber ring is used and the integrated rubber ring can be held by an ear portion for holding the liquid-tight ring. Thus, the retainer becomes unnecessary. However, a front end part of the integrated rubber ring may be turned up, for example, by a friction force generated between the above connector and a mating connector when the connector and the mating connector are connected.

### Means to Solve the Problem

The present disclosure is directed to a connector connectable to a mating connector including a mating receptacle, the connector being provided with a housing including a tower portion fittable into the mating receptacle and a rubber plug to be externally fit to the tower portion, the rubber plug including an annular water stop portion to be arranged between an outer peripheral surface of the tower portion and an inner peripheral surface of the mating receptacle with the tower portion fit in the mating receptacle, a tubular vibration resistance portion extending forward along the outer peripheral surface of the tower portion from the water stop portion and a turn-up suppressing portion bridged in a front end part of the vibration resistance portion for suppressing the rubber plug from being turned up rearward by being caught by a front end part of the tower portion.

### Effect of the Invention

According to the present disclosure, it is possible to suppress rattling between a connector and a mating connector by a vibration resistance portion in a connected state of the connectors and suppress a rubber ring from being turned up rearward by a turn-up suppressing portion when the connector and the mating connector are connected.

### BRIEF DESCRIPTION OF THE DRAWINGS

FIG. 1 is a perspective view showing a state where a connector and a mating connector are connected.

FIG. 2 is an exploded perspective view showing the connector and the mating connector in a disassembled state.

FIG. 3 is a plan view showing the state where the connector and the mating connector are connected.

FIG. 4 is a side view showing the state where the connector and the mating connector are connected.

FIG. 5 is a front view of a housing.

FIG. 6 is a front view of the connector.

FIG. 7 is a section along A-A of FIG. 3.

FIG. 8 is a section along B-B of FIG. 3.

FIG. 9 is a section along C-C of FIG. 4.

FIG. 10 is a perspective view of a rubber plug according to a first embodiment when obliquely viewed from front.

FIG. 11 is a perspective view of the rubber plug according to the first embodiment when obliquely viewed from behind.

FIG. 12 is a perspective view of a rubber plug according to a second embodiment when obliquely viewed from front.

### DETAILED DESCRIPTION TO EXECUTE THE INVENTION

### Description of Embodiments of Present Disclosure

First, embodiments of the present disclosure are listed and described.
(1) The connector of the present disclosure is connectable to a mating connector including a mating receptacle and provided with a housing including a tower portion fittable into the mating receptacle and a rubber plug to be externally fit to the tower portion, the rubber plug including an annular water stop portion to be arranged between an outer peripheral surface of the tower portion and an inner peripheral surface of the mating receptacle with the tower portion fit in the mating receptacle, a tubular vibration resistance portion extending forward along the outer peripheral surface of the tower portion from the water stop portion and a turn-up suppressing portion provided in a front end part of the vibration resistance portion for suppressing the rubber plug from being turned up rearward by being caught by a front end part of the tower portion.

According to the above connector, water can be stopped between the mating receptacle and the tower portion by the annular water stop portion of the rubber plug. If the mating receptacle and the tower portion are in contact only at the water stop portion, the front end part of the tower portion easily vibrates about the water stop portion. Accordingly, the tubular vibration resistance portion extending forward along the outer peripheral surface of the tower portion from the water stop portion is provided in the above connector. Thus, the vibration of the front end part of the tower portion can be suppressed. If the tower portion is fit into the mating receptacle in the case of providing such a vibration resistance portion, the rubber plug may be turned up rearward. However, since the turn-up suppressing portion is provided in the front end part of the vibration resistance portion in the above connector, the rubber plug can be suppressed from being turned up rearward by being caught by the front end part of the tower portion.
(2) Preferably, the tower portion includes at least a pair of cavities open in a front-rear direction and a partition wall partitioning between the pair of adjacent cavities, and the turn-up suppressing portion is bridged in the front end part of the vibration resistance portion and capable of contacting the partition wall from front.

Since terminals are generally accommodated in cavities, a partition wall for insulating the terminals from each other is provided between the pair of adjacent cavities. The rubber plug can be suppressed from being turn up rearward by the turn-up suppressing portion contacting the partition wall from front, utilizing such a partition wall.
(3) Preferably, the partition wall includes a partition wall opening open forward and the turn-up suppressing portion enters the partition wall opening from front.

The partition wall may be provided with the partition wall opening for lightening to prevent sinks and the like during the molding of the partition wall. The rubber plug can be more suppressed from being turned up rearward by the turn-up suppressing portion entering the partition wall opening of the partition wall from front, utilizing such a partition wall opening.
(4) Preferably, the front end part of the tower portion includes a cut portion formed by cutting between an inner wall of the partition wall opening and the outer peripheral surface of the tower portion, and the turn-up suppressing portion enters the partition wall opening and the cut portion from front.

The turn-up suppressing portion enters the partition wall opening and the cut portion, thereby being firmly hooked to the front end part of the tower portion.
(5) Preferably, a plurality of ridge portions are provided to extend in the front-rear direction on an outer peripheral surface of the vibration resistance portion and provided at intervals from each other in a circumferential direction of the vibration resistance portion.

Since the plurality of ridge portions contact the inner peripheral surface of the mating receptacle when the tower portion is fit into the mating receptacle, a contact area becomes smaller than when the plurality of ridge portions contact the inner peripheral surface of the mating receptacle over an entire periphery, a friction force generated between the mating receptacle and the vibration resistance portion is reduced and a force necessary for connection can be reduced.

### DETAILS OF EMBODIMENTS OF PRESENT DISCLOSURE

A specific example of a connector of the present disclosure is described below with reference to the drawings. Note that the present disclosure is not limited to these illustrations, but is represented by claims and intended to include all changes in the scope of claims and in the meaning and scope of equivalents.

### First Embodiment

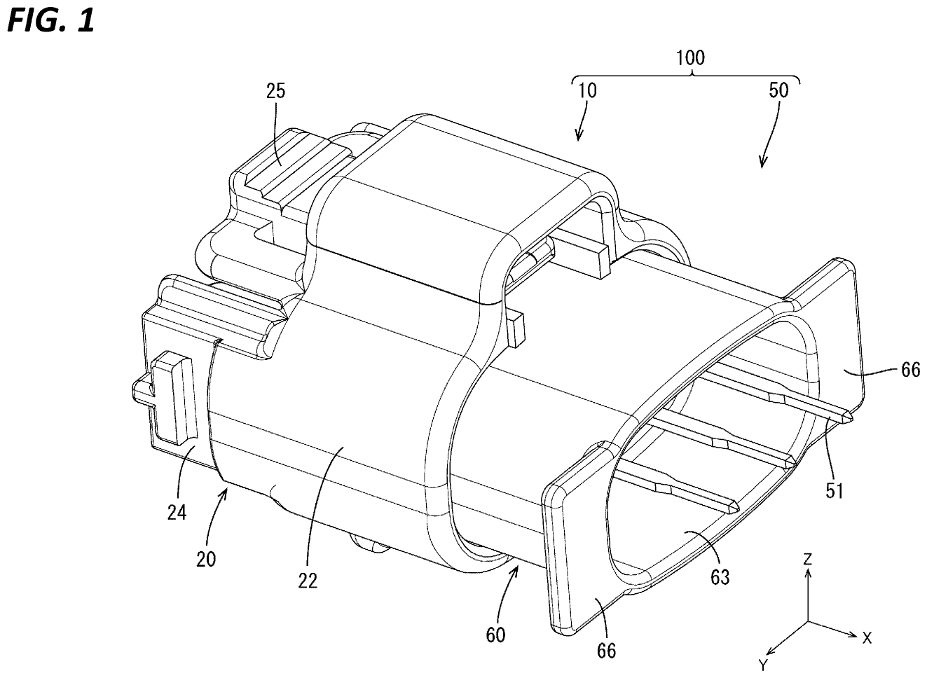

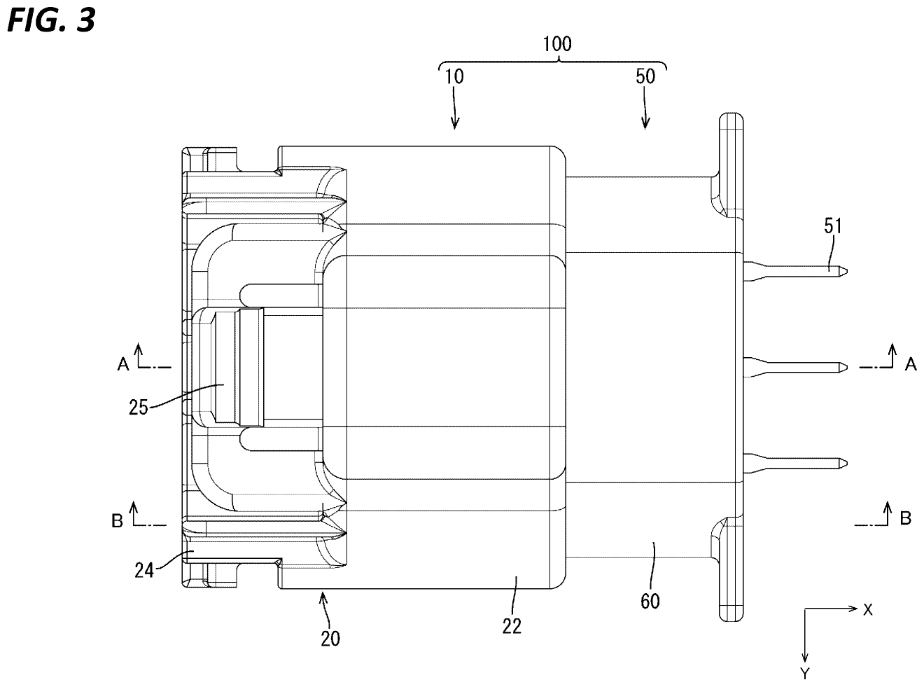

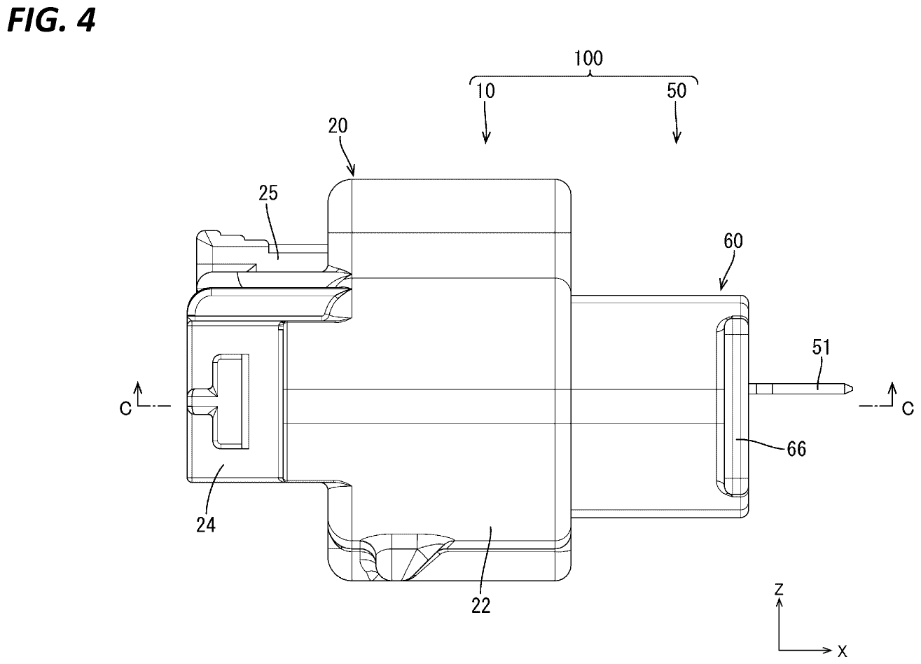

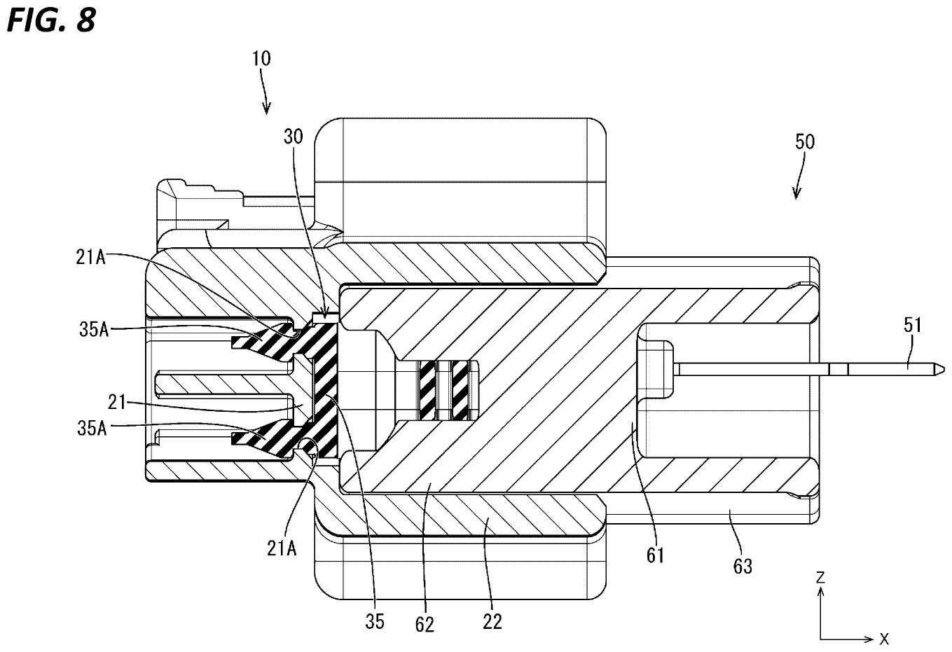

A first embodiment of the present disclosure is described with reference to FIGS. 1 to 11. In the following description, a direction indicated by an arrow Z is referred to as a vertical direction, a direction indicated by an arrow X is referred to as a front-rear direction, a direction indicated by an arrow Y is referred to as a lateral direction, and connection surface sides of a connector 10 and a mating connector 50 are referred to as front sides. Note that, for a plurality of identical members, only some members may be denoted by a reference sign and the other members may not be denoted by the reference sign.

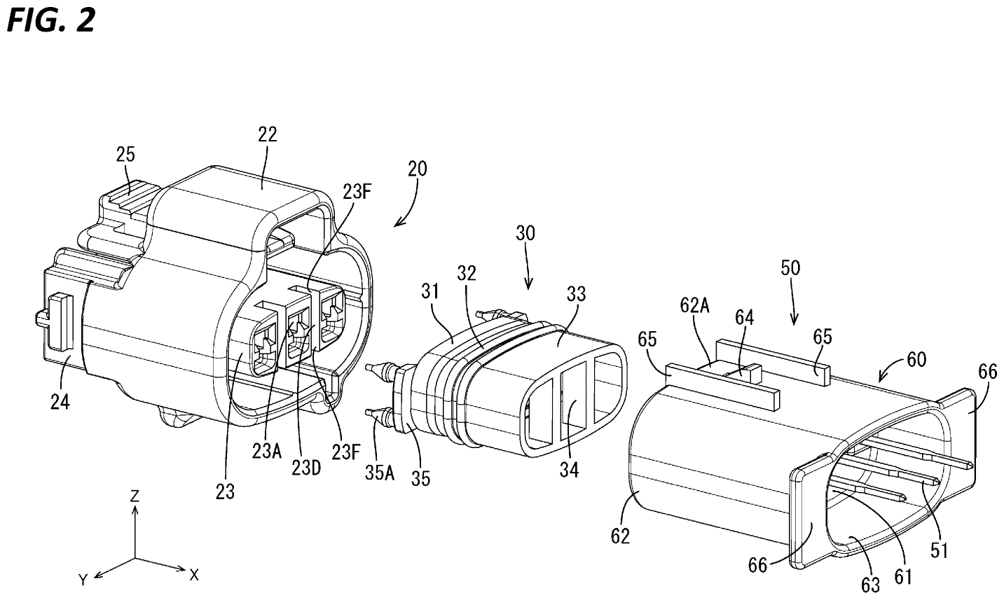

The connector 10 of this embodiment is provided with a housing 20 and a rubber plug 30 as shown in FIG. 2. The connector 10 is connectable to the mating connector 50. A connector unit 100 is constituted by the connector 10 and the mating connector 50.

### [Mating Connector]

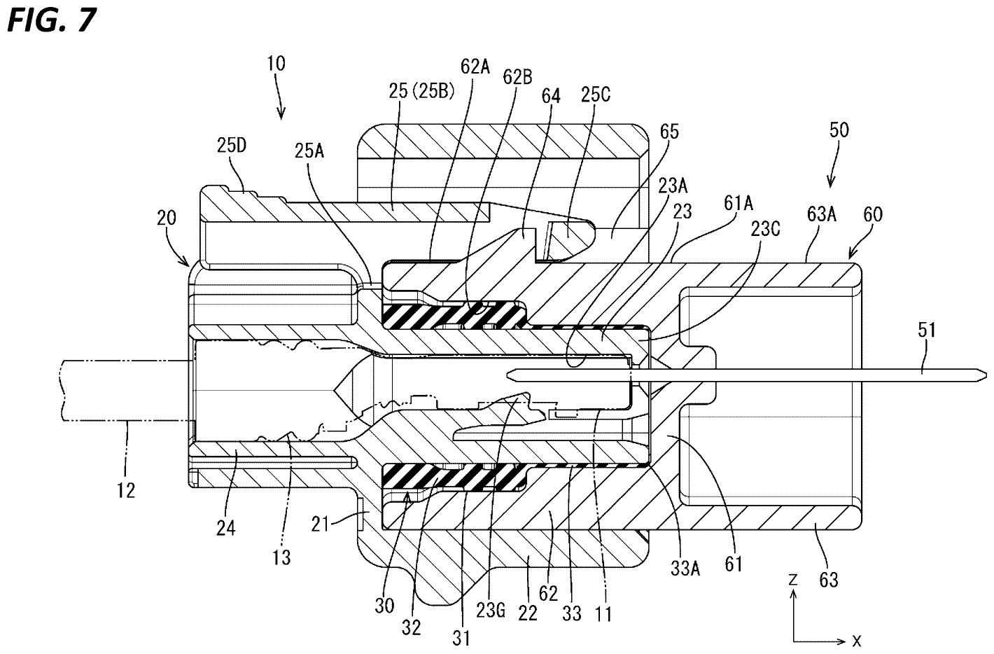

The mating connector 50 is provided with a mating housing 60 and mating terminals 51. The mating housing 60 is made of insulating synthetic resin and, as shown in FIG. 7, provided with a plate-like body portion 61, a front tube portion 62 extending forward from the peripheral edge of the body portion 61 and a rear tube portion 63 extending rearward from the peripheral edge of the body portion 61. The front tube portion 62 is in the form of a tubular receptacle open forward, and the back wall of the front tube portion 62 is constituted by the body portion 61. The rear tube portion 63 is in the form of a tubular receptacle open rearward, and the back wall of the rear tube portion 63 is constituted by the body portion 61.

As shown in FIG. 2, the front tube portion 62, the body portion 61 and the rear tube portion 63 are successively provided in this order. An outer peripheral surface 62A of the front tube portion 62, an outer peripheral surface 61A of the body portion 61 and an outer peripheral surface 63A of the rear tube portion 63 are continuous and flush with each other. A lock receiving portion 64A is provided on the outer peripheral surface 62A of the front tube portion 62. A pair of protection walls 65 are provided on both left and right sides of the lock receiving portion 64 on the outer peripheral surface 62A of the front tube portion 62. The rear end of the rear tube portion 63 is provided with a pair of flange portions 66 protruding in the lateral direction.

The mating terminal 51 is a male terminal made of metal and, as shown in FIG. 2, tab-shaped. The mating terminal 51 is formed into a predetermined shape by a known method such as press working, cutting or casting. An arbitrary metal such as copper, copper alloy, aluminum, aluminum alloy or stainless steel can be appropriately selected as a metal constituting the mating terminal 51 if necessary. A plating layer may be formed on the surface of the mating terminal 51. An arbitrary metal such as tin, nickel or silver can be appropriately selected as a metal constituting the plating layer if necessary.

As shown in FIG. 7, the mating terminal 51 is held by the body portion 61 by being passed through the body portion 61 of the mating housing 60 in the front-rear direction. Out of the mating terminal 51, a part corresponding to the front tube portion 62 projects to the vicinity of a center in the front-rear direction of the front tube portion 62 from the body portion 61. Out of the mating terminal 51, a part corresponding to the rear tube portion 63 projects further rearward than the opening edge of the rear tube portion 63 from the body portion 61.

### [Connector]

The connector 10 is provided with the housing 20, terminals 11 and the rubber plug 30. The housing 20 is made of insulating synthetic resin and, as shown in FIG. 7, provided with a plate-like coupling portion 21, a receptacle 22 extending forward from the peripheral edge of the coupling portion 21, a tower portion 23 extending forward from the coupling portion 21 inside the receptacle 22, a wire accommodating portion 24 extending rearward from the coupling portion 21 and a lock arm 25 provided on the upper surface of the coupling portion 21.

The terminal 11 is a female terminal made of metal and in the form of a rectangular tube. The terminal 11 is formed into a predetermined shape by a known method such as press working, cutting or casting. An arbitrary metal such as copper, copper alloy, aluminum, aluminum alloy or stainless steel can be appropriately selected as a metal constituting the mating terminal 11 if necessary. A plating layer may be formed on the surface of the mating terminal 11. An arbitrary metal such as tin, nickel or silver can be appropriately selected as a metal constituting the plating layer if necessary.

As shown in FIG. 2, the receptacle 22 is in the form of a tubular receptacle open forward. The back wall of the receptacle 22 is constituted by the coupling portion 21. Out of the receptacle 22, a part corresponding to the lock arm 25 bulges upward, and a front end part of the lock arm 25 is accommodated in this bulging part.

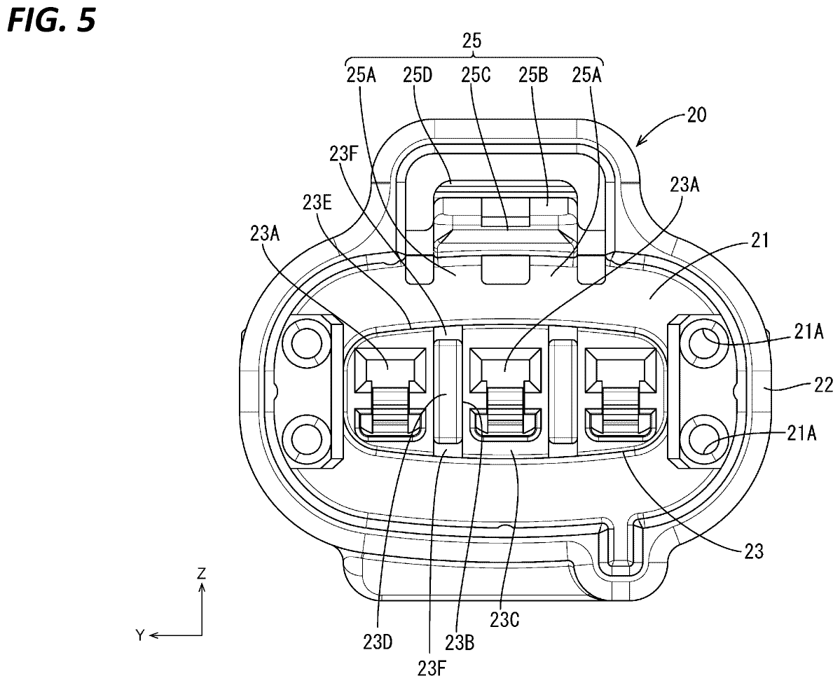

As shown in FIG. 5, the tower portion 23 has a substantially rectangular shape long in the lateral direction in a front view. The tower portion 23 includes at least a pair of (three in the present disclosure) cavities 23A open in the front-rear direction and partition walls 23B partitioning between a pair of adjacent cavities 23A.

The partition wall 23B includes a partition wall opening 23D open forward in a front end part 23C of the tower portion 23. As shown in FIG. 5, the partition wall opening 23D is formed substantially in the same height range as the cavities 23A. The front end part 23C of the tower portion 23 includes a pair of upper and lower cut portions 23F formed by cutting between the inner wall of the partition wall opening 23D and an outer peripheral surface 23E of the tower portion 23. The cut portions 23F are formed to correspond to the vicinity of the front end of the tower portion 23. The partition wall opening 23D is formed to correspond to substantially the entire length in the front-rear direction of the tower portion 23.

As shown in FIG. 7, the wire accommodating portion 24 accommodates wires 12 connected to the terminals 11 and rubber plugs 13 externally fit to the wires 12. The wire 12 is such a known wire that a core wire made of an electrically conductive single core wire or metal thin wires is surrounded by an insulation coating. The rubber plug 13 is sandwiched between the insulation coating of the wire 12 and the inner peripheral surface of the wire accommodating portion 24, thereby preventing water entrance into the cavity 23A of the tower portion 23.

A bottom wall of the cavity 23A is formed with a locking lance 23G. The locking lance 23G is cantilevered and shaped to extend forward. If the terminal 11 is inserted into the cavity 23A from behind, the locking lance 23G is deflected and deformed downward. If the terminal 11 is inserted to a proper position, the locking lance 23G returns to an original shape and locks the terminal 11. In this way, the terminal 11 is held in the cavity 23A in the tower portion 23.

The lock arm 25 includes a base end part 25A rising upward from the coupling portion 25, an arm portion 25B pivotable about the base end part 25A, a locking portion 25C formed in a front end part of the arm portion 25B and a releasing portion 25D formed in a rear end part of the arm portion 25B. The arm portion 25B is coupled to the base end part 25A at a position near a center thereof.

If the connector 10 is connected to the mating connector 50, the locking portion 25C rides on the lock receiving portion 64, whereby the arm portion 25B resiliently pivots. If the locking portion 25C rides over the lock receiving portion 64, the arm portion 25B resiliently returns and the locking portion 25C locks the lock receiving portion 64. In this way, the connector 10 and the mating connector 50 are held in a connected state.

If the releasing portion 25D is pushed downward, the front end part of the arm portion 25B is pivoted and displaced upward and the locking of the locking portion 25C and the lock receiving portion 64 is released. The connector 10 and the mating connector 50 are separable by being pulled apart from each other in this locking released state.

### [Rubber Plug]

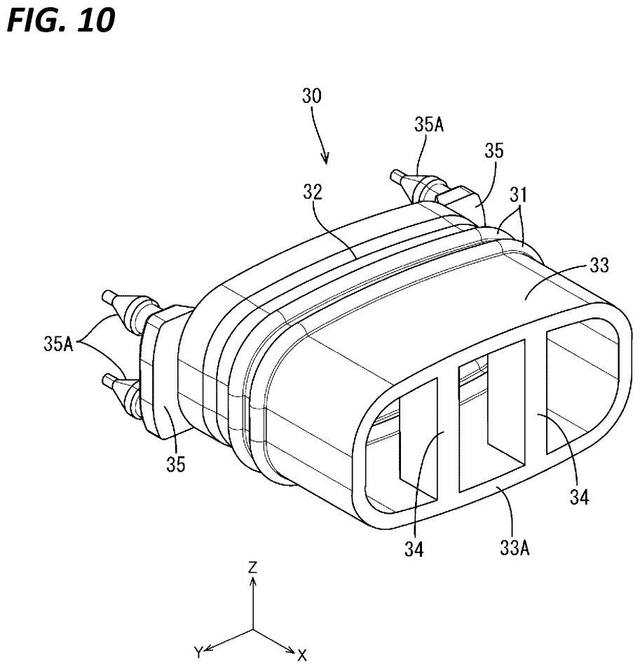

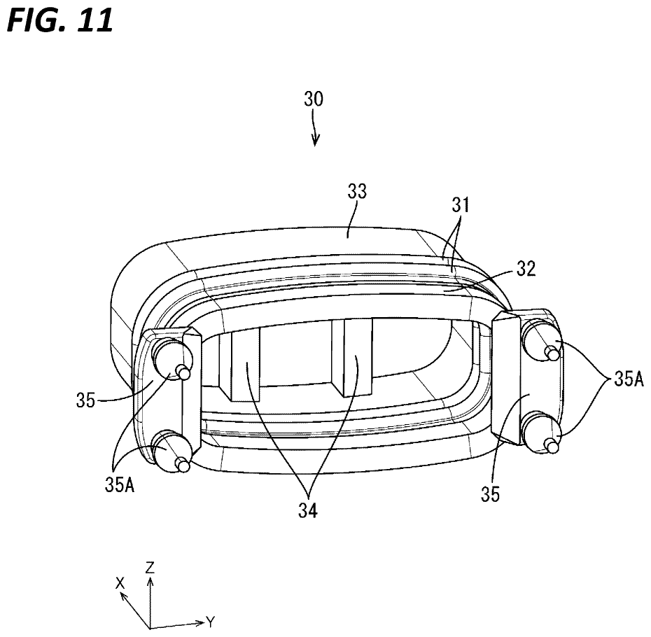

The rubber plug 30 is a resilient member made of synthetic rubber, natural rubber or the like and, as shown in FIGS. 10 and 11, formed into a rectangular annular shape with rounded corners. The rubber plug 30 is provided with a tubular water stop portion 32, a tubular vibration resistance portion 33 extending forward from the water stop portion 32, a plurality of turn-up suppressing portions 34 bridged in a front end part of the vibration resistance portion 33 and a pair of retaining portions 35 formed to protrude toward both lateral sides in the rear end of the water stop portion 32. The water stop portion 32 and the vibration resistance portion 33 of the rubber plug 30 are externally fit to the tower portion 23.

The water stop portion 32 includes lips 31 seamlessly formed in a circumferential direction of the water stop portion 32. A plurality of (two in the present disclosure) the lips 31 are provided side by side in the front-rear direction. As shown in FIG. 7, the lip 31 includes a part projecting radially outward from the outer peripheral surface of the water stop portion 32 and a part projecting radially inward from the inner peripheral surface of the water stop portion 32. If the tower portion 23 is fit into the front tube portion 62 of the mating housing 60, the water stop portion 32 is sandwiched between an inner peripheral surface 62B of the front tube portion 62 and the outer peripheral surface 23E of the tower portion 23, whereby the lips 31 are squeezed. That is, the lips 31 are held in close contact with both the inner peripheral surface 62B of the front tube portion 62 and the outer peripheral surface 23E of the tower portion 23, whereby water is stopped between the front tube portion 62 and the tower portion 23.

The vibration resistance portion 33 is formed into a tubular shape extending forward along the outer peripheral surface 23E of the tower portion 23 from the water stop portion 32. If the front part 23C of the tower portion 23 is going to vibrate about the lips 31, vibration is suppressed by the vibration resistance portion 33. In this way, the abrasion of a contact point of the terminal 11 and the mating terminal 51 due to vibration can be suppressed.

As shown in FIGS. 10 and 11, the retaining portion 35 includes a pair of projections 35A. The projection 35A has a substantially conical shape. As shown in FIG. 5, the coupling portion 21 of the housing 20 is formed with retaining holes 21A, into which the projections 35A are mounted. A maximum outer diameter of the projection 35A is larger than a hole diameter of the retaining hole 21A. If the projections 35A are mounted into the retaining holes 21A, the projections 35A are locked to hole edge parts of the retaining holes 21A from behind, whereby the rubber plug 30 is held in the housing 20.

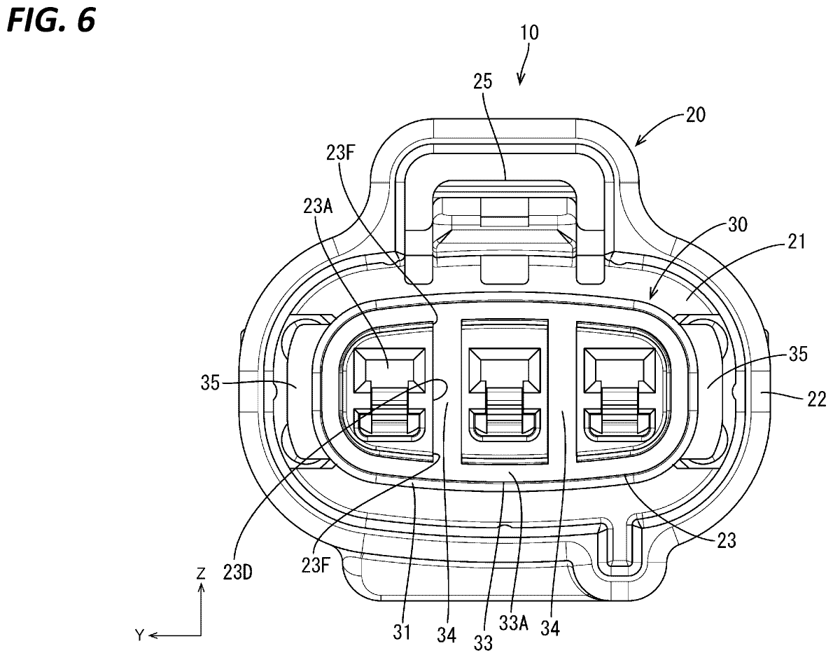

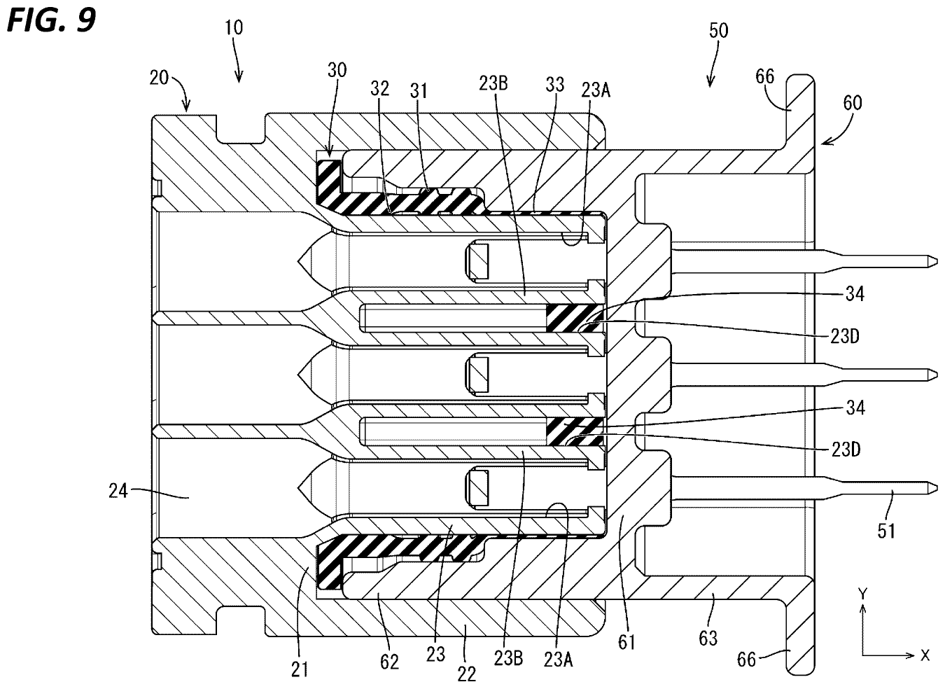

As shown in FIG. 10, the turn-up suppressing portion 34 is in the form of a flat plate coupling upper and lower sides of the inner peripheral surface of a front end part 33A of the vibration resistance portion 33. The turn-up suppressing portion 34 is long in the vertical direction, and a pair of the turn-up suppressing portions 34 are provided side by side in the lateral direction. A dimension in the front-rear direction of the turn-up suppressing portion 34 is longer than a dimension in the lateral direction and constant entirely in the vertical direction. As shown in FIGS. 6 and 9, the turn-up suppressing portion 34 enters the partition wall opening 23D and the pair of cut portions 23F located on both upper and lower sides of the partition wall opening 23D and is accommodated inside. When the connector 10 and the mating connector 50 are connected, the rubber plug 30 is suppressed from being turned up by the turn-up suppressing portions 34 being caught by the back surfaces (rear surfaces) of the pairs of cut portions 23F if the rubber plug 30 is going to be turned up by the inner peripheral surface 62B of the front tube portion 62 of the mating housing 60 contacting the front end part 33A of the vibration resistance portion 33.

### [Functions and Effects of First Embodiment]

The connector 10 of the present disclosure is connectable to the mating connector 50 including the front tube portion 62 and provided with the housing 20 including the tower portion 23 fittable into the front tube portion 62 and the rubber plug 30 to be externally fit to the tower portion 23, and the rubber plug 30 includes the annular water stop portion 32 to be arranged between the outer peripheral surface 23E of the tower portion 23 and the inner peripheral surface 62B of the front tube portion 62 with the tower portion 23 fit in the front tube portion 62, the tubular vibration resistance portion 33 extending forward along the outer peripheral surface 23E of the tower portion 23 from the water stop portion 32 and the turn-up suppressing portions 34 provided in the front end part 33A of the vibration resistance portion 33 for suppressing the rubber plug 30 from being turned up rearward by being caught by the front end part 23C of the tower portion 23.

According to the above connector 10, water can be stopped between the front tube portion 62 and the tower portion 32 by the annular water stop portion 32 of the rubber plug 30. If the front tube portion 62 and the tower portion 23 are in contact only at the lips 31, the front end part 23C of the tower portion 23 easily vibrates about the lips 31. Accordingly, the tubular vibration resistance portion 33 extending forward along the outer peripheral surface 23E of the tower portion 23 from the water stop portion 32 is provided in the above connector 10. Thus, the vibration of the front end part 23C of the tower portion 23 can be suppressed. In the case of providing such a vibration resistance portion 33, the rubber plug 30 may be turned up rearward if the tower portion 23 is fit into the front tube portion 62. However, since the turn-up suppressing portions 34 are provided in the front end part 33A of the vibration resistance portion 33 in the above connector 10, the rubber plug 30 can be suppressed from being turned up rearward by the turn-up suppressing portions 34 being caught by the front end part 23C of the tower portion 23.

Preferably, the tower portion 23 includes at least a pair of the cavities 23A open in the front-rear direction and the partition walls 23B partitioning between the pair of adjacent cavities 23A, and the turn-up suppressing portions 34 are bridged in the front end part 33A of the vibration resistance portion 33 and can contact the partition walls 23B from front.

Since the terminals 11 are generally accommodated in the cavities 23A, the partition walls 23B for insulating the terminals 11 from each other are provided between the pair of adjacent cavities 23A. The rubber plug 30 can be suppressed from being turned up rearward by the turn-up suppressing portions 34 contacting the partition walls 23B from front, utilizing such partition walls 23B.

Preferably, the partition wall 23B includes the partition wall opening 23D open forward, and the turn-up suppressing portion 34 enters the partition wall opening 23D from front.

The partition wall 23B may be provided with the partition wall opening 23D for lightening to prevent sinks and the like during the molding of the partition wall 23B. The rubber plug 30 can be more suppressed from being turned up rearward by the turn-up suppressing portion 34 entering the partition wall opening 23D of the partition wall 23B from front, utilizing such a partition wall opening 23D.

Preferably, the front end part 23C of the tower portion 23 includes the cut portions 23F formed by cutting between the inner wall of the partition wall opening 23D and the outer peripheral surface 23E of the tower portion 23, and the turn-up suppressing portion 34 enters the partition wall opening 23D and the cut portions 23F from front. The turn-up suppressing portion 34 enters the partition wall opening 23D and the cut portions 23F, whereby the turn-up suppressing portion 34 is firmly hooked to the front end part 23C of the tower portion 23.

### Second Embodiment

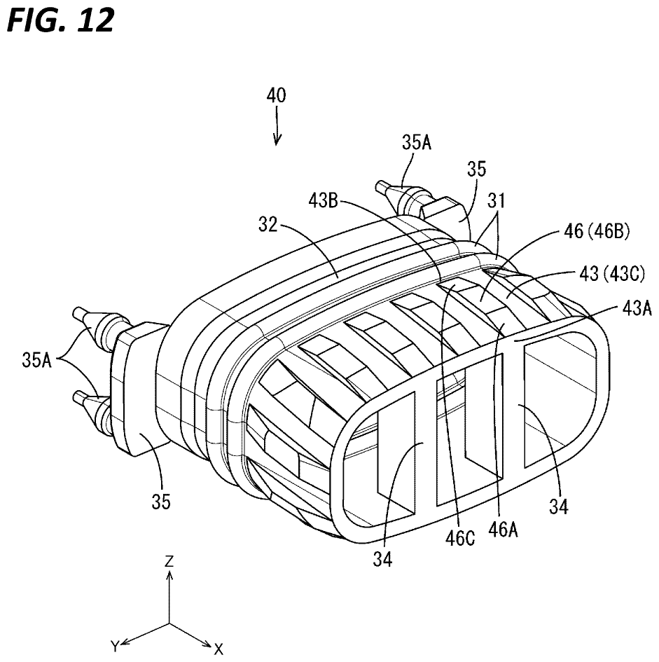

A second embodiment of the present disclosure is described with reference to FIG. 12. In the second embodiment, the rubber plug 30 of the first embodiment is changed. In the configuration of a rubber plug 40 of the second embodiment, the same components as those of the rubber plug 30 of the first embodiment are denoted by the same reference signs and the description thereof may be omitted.

The rubber plug 40 is a resilient member made of synthetic rubber, natural rubber or the like and formed into a rectangular annular shape with rounded corners. The rubber plug 40 is provided with a tubular water stop portion 32, a tubular vibration resistance portion 43 extending forward from the water stop portion 32, a plurality of turn-up suppressing portions 34 bridged in a front end part 43A of the vibration resistance portion 43 and a pair of retaining portions 35 formed to protrude toward both lateral sides in the rear end of the water stop portion 32.

A plurality of ridge portions 46 are integrally provided to extend in the front-rear direction on the outer peripheral surface of the vibration resistance portion 43. The plurality of ridge portions 46 are provided at intervals from each other in a circumferential direction of the vibration resistance portion 43. The ridge portion 46 is linearly formed from the front end part 43A to a rear end part 43B of the vibration resistance portion 43. The ridge portion 46 is in the form of a block trapezoidal when viewed from a direction orthogonal to the front-rear direction.

In particular, the ridge portion 46 has a front tapered surface 46A inclined away from the outer peripheral surface 43C of the vibration resistance portion 43 toward a rear side from the front end part 43A of the vibration resistance portion 43, a flat surface 46B extending rearward in parallel to the outer peripheral surface 43C of the vibration resistance portion 43 from the rear end of the front tapered surface 46A and a rear tapered surface 46C inclined toward the outer peripheral surface 43C of the vibration resistance portion 43 toward the rear side from the rear end of the flat surface 46B and reaching the rear end part 43B of the vibration resistance portion 43.

As described above, in this embodiment, the plurality of ridge portions 46 are provided to extend in the front-rear direction on the outer peripheral surface 43C of the vibration resistance portion 43 and provided at intervals from each other in the circumferential direction of the vibration resistance portion 43.

Since the plurality of ridge portions 46 contact an inner peripheral surface 62B of a front tube portion 62 when the tower portion 23 is fit into the front tube portion 62, a contact area becomes smaller than when the plurality of ridge portions 46 contact the inner peripheral surface 62B of the front tube portion 62 over an entire periphery, a friction force generated between the front tube portion 62 and the vibration resistance portion 43 is reduced and a force necessary for connection can be reduced.

### OTHER EMBODIMENTS

(1) Although the water stop portion 32 is illustrated to include the lips 31 in the above embodiment, a water stop portion may include no lips.
(2) Although the turn-up suppressing portions 34 are illustrated to be bridged in the front end part 33A of the vibration resistance portion 33 in the above embodiment, turn-up suppressing portions may be formed to protrude radially inward from the front end part 33A of the vibration resistance portion 33. That is, the turn-up suppressing portions may not couple arbitrary two positions in the front end part 33A of the vibration resistance portion 33.
(3) Although the turn-up suppressing portion 34 is illustrated to enter the partition wall opening 23D and the pair of cut portions 23F from front in the above embodiment, a turn-up suppressing portion may contact a front end part of a tower portion from front if a partition wall opening and cut portions are not present.
(4) Although the contact area is reduced by providing the ridge portions 46 in the second embodiment, a vibration resistance portion may be formed to be thicker than the vibration resistance portion 33 of the first embodiment and a contact area may be reduced by forming grooves in this vibration resistance portion.

### LIST OF REFERENCE NUMERALS

10: connector, 11: terminal, 12: wire, 13: rubber plug
20: housing, 21: coupling portion, 21A: retaining hole, 22: receptacle, 23: tower portion, 23A: cavity, 23B: partition wall, 23C: front end part, 23D: partition wall opening, 23E: outer peripheral surface, 23F: cut portion, 23G: locking lance, 24: wire accommodating portion, 25: lock arm, 25A: base end part, 25B: arm portion, 25C: locking portion, 25D: releasing portion
30: rubber plug, 31: lip, 32: water stop portion, 33: vibration resistance portion, 33A: front end part, 34: turn-up suppressing portion, 35: retaining portion, 35A: projection
40: rubber plug, 43: vibration resistance portion, 43A: front end part, 43B: rear end part, 43C: outer peripheral surface, 46: ridge portion, 46A: front tapered surface, 46B: flat surface, 46C: rear tapered surface
50: mating connector, 51: mating terminal
60: mating housing, 61: body portion, 61A: outer peripheral surface, 62: front tube portion (mating receptacle), 62A: outer peripheral surface, 62B: inner peripheral surface, 63: rear tube portion, 63A: outer peripheral surface, 64: lock receiving portion, 65: protection wall, 66: flange portion
100: connector unit

1. A connector connectable to a mating connector including a mating receptacle, comprising:
a housing including a tower portion fittable into the mating receptacle; and
a rubber plug to be externally fit to the tower portion,
the rubber plug including an annular water stop portion to be arranged between an outer peripheral surface of the tower portion and an inner peripheral surface of the mating receptacle with the tower portion fit in the mating receptacle, a tubular vibration resistance portion extending forward along the outer peripheral surface of the tower portion from the water stop portion and a turn-up suppressing portion provided in a front end part of the vibration resistance portion for suppressing the rubber plug from being turned up rearward by being caught by a front end part of the tower portion.

2. The connector of claim 1, wherein the tower portion includes at least a pair of cavities open in a front-rear direction and a partition wall partitioning between the pair of adjacent cavities, and the turn-up suppressing portion is bridged in the front end part of the vibration resistance portion and capable of contacting the partition wall from front.

3. The connector of claim 2, wherein the partition wall includes a partition wall opening open forward and the turn-up suppressing portion enters the partition wall opening from front.

4. The connector of claim 3, wherein the front end part of the tower portion includes a cut portion formed by cutting between an inner wall of the partition wall opening and the outer peripheral surface of the tower portion, and the turn-up suppressing portion enters the partition wall opening and the cut portion from front.

5. The connector of claim 1, wherein a plurality of ridge portions are provided to extend in a front-rear direction on an outer peripheral surface of the vibration resistance portion and provided at intervals from each other in a circumferential direction of the vibration resistance portion.
